(19) United States
(12) Patent Application Publication
(10) Pub. No.: US 2002/0139468 A1
(43) Pub. Date: Oct. 3, 2002

(54) Tire building machine

(76) Inventor: Florian Fischer, Ebersberg (DE)

Correspondence Address: ROBERT W. BECKER & ASSOCIATES, Suite B, 707 Highway 66 East, Tijeras, NM, 87059, US

(21) Appl. No.: 10/066,282

(22) Filed: Feb. 1, 2002

(30) Foreign Application Priority Data
Feb. 2, 2001 (DE) 101 04 774.6

(51) Int. Cl. B29D 30/00

(52) U.S. Cl. 156/123; 156/396; 156/397; 156/408

(57) ABSTRACT

A tire building machine for building a tread strip onto a carcass is provided and includes a carcass support on which the carcass is rotatably mounted, and a tread strip feed device via which a tread strip is fed onto the carcass. The tread strip feed device includes a linear path support assembly on which a tread strip is supported in a substantially linear disposition. The path support assembly extends from one end of the tread strip feed device at which a cutting device may perform a cutting operation to an end adjacent the carcass. The tread strip feed device is raisable to a feed position at which the tread strip extends tangentially relative to the carcass for feeding the tread strip thereonto in a tire building process.

### BACKGROUND OF THE INVENTION

The present invention relates to a tire building machine.

Tire building machines for feeding tread strips onto tire carcasses typically include a cutting device for cutting the tread strips. The length of the tread strips is set by the operation of the cutting device and the tread strips are built up onto the carcass during rotation of the carcass.

One attempts to exactly set the length of the tread strips to the greatest extent possible at the start of the tire building process. On the one hand, it is important that the tread strip not be too short as otherwise a discontinuity at a butt joint on the carcass will remain. An overly long length of the tread strip must be manually removed by means of a cutting knife. Also, the danger regularly exists that the quality of the tire being built is negatively impacted if the tire builder does not work with precision.

The tire builder requires working space adjacent to the carcass for the follow-on work. In view of the fact that the binding rubber extruder operates with high pressure on the respective side of the carcass oppositely disposed to the side at which the tread strip feed device is disposed, it is desirable to not further modify the binding rubber extruder side of the carcass with a horizontal displacement feature, which would make the construction of the tire assembly area more expensive.

In this connection, it has been proposed to dispose the tire tread feed device at a distance from the carcass. In connection with such a solution, the tread strip has heretofore been fed to a location somewhat central to the carcass, thereafter bent upwardly, and subsequently bent in an opposite direction to be laid onto the carcass. This solution is, however, not entirely favorable as the curving of the tread strip effects an elongation of the tread strip, whereby the elongated tread strip gradually reduces in length after a certain period of time.

Additionally, it has already been proposed to feed the tread strips to the underside of the carcass. In view of the fact that only a few centimeters of space remain between the carcass underside and the tread strips, a disposition of the tread strips thereat is exceptionally unfavorable from an ergonomic point of view and is all the more unfavorable in connection with large carcasses. Additionally, the operation of the cutting device is, for all practical purposes, only possible if the tire builder bends to reach the cutting location. Moreover, in connection with such an approach, the extruder must be displaceable in a translational manner relative to the carcass, which leads to a more complicated construction of the tire building assembly and, on the other hand, effects a corresponding reduction in the precision of the feed of the binding rubber onto the tire being assembled.

In German Patent Application P 100 38 471.4, it has been proposed to dispose the tread strips under tension in order to achieve an improvement in the precision of the tread strip feed by the tread feed device. This approach, however, requires a fixed disposition of the tread strip feed path.

Further, it has been proposed to measure the length of the tread strips via a length measuring device and, based upon the thus obtained empirical tread length values as set forth in a table incorporating these empirical values, to operate the cutting device to cut tread strips of differing lengths in connection with the various carcass diameters.

### SUMMARY OF THE INVENTION

In contrast to the aforedescribed approaches, the present invention offers a solution to the challenge of providing a tire building machine which makes possible an improved precision in the disposition of the tread strips in a ready position relative to the tire carcass, whereby, at the same time, the follow-on work to eliminate the joint discontinuities is simplified.

This inventive approach is revealed further in advantageous embodiments described herein.

The solution of the present invention surprisingly offers increased precision in connection with the build-up of a tread strip onto a carcass. In accordance with the present invention, the tread strip is fed in a linear or straight manner in contrast to the bent or curved feed of tread strips in accordance with the state of the art. Heretofore, the feed of tread strips in the conventional manner has evidently resulted in the elongation of the tread strips and this phenomenon has indeed occurred if the tread strip has been re-oriented in a straight or linear manner after bending or curving thereof or has been bent in an opposing direction to bring it into corresponding orientation with the curvature of the carcass. In accordance with the present invention, the tables which are to be used to determine the compensation for the elongation of the tread strips can be eliminated. At the same time, it is not of any critical significance to pay attention to the duration of the tread strip feed, in view of the fact that the tread strip is no longer subjected to a length reducing correction of its elongated length over a certain time period due to the memory of the mass which is used, as no elongation of the tread strip occurs during the feed of the tread strip in accordance with the present invention.

In the tire building device of the present invention, the path support assembly thereof is swung and moved relative to the tire carcass in its entirety while supporting thereon the tread strip in a straight or linear disposition. This calls for, on the one hand, a swing movement relative to a linkage and, on the other hand, a translatory movement of the path support assembly, the swing movement and the translatory movement each being configurable in any suitable desired manner. Preferably, it is provided that a linkage is clearly spaced from the carcass—that is, disposed at a location substantially adjacent the respective opposite end of the path support assembly which is not adjacent the tire carcass. In connection with this solution, the required swing angle is relatively small. The translatory movement—that is, the substantially horizontal movement—of the path support assembly can be provided by a suitable guide rail. Such a guide rail can be configured in a comparatively economical manner in view of the fact that the mounting force is limited and, in particular, is clearly less than the extrusion force which must be absorbed by the carcass support supporting the carcass.

In accordance with the present invention, it is particularly advantageous that an accommodation of the different carcass diameters can be undertaken without additional measures. The feed position—that is, the position of the tread strip tangential to the carcass surface—can be adjusted to any desired setting and, to be sure, can be effected manually or via an automatic control.

It is, additionally, also advantageous that, via the horizontal movement capability of the path support assembly, the region in front of the carcass can be made available without additional measures. In this connection, the tire builder can operate in an ergonomically favorable manner on the discontinuity locations, which leads to an enhancement of the quality of the tire production.

Also, the cutting device is, in connection with the present invention, preferably substantially always operated at a working height in the range of, for example, 1 m to 1.20 m. In this manner, it is ensured that the tire builder can precisely perform the cutting operation.

### BRIEF DESCRIPTION OF HE DRAWINGS

Further details, advantages and aspects of the present invention can be found in the hereinafter following description of an embodiment of the present invention taken in connection with the figures of the drawings, in which:

FIG. 1 is a perspective view of one embodiment of the tire building machine of the present invention;

FIG. 2 is a view of the tire building machine shown in FIG. 1 in a first feed position; and

FIG. 3 is a view of the tire building machine shown in FIG. 1 in a second feed position.

### DETAILED DESCRIPTION OF THE PREFERRED EMBODIMENT

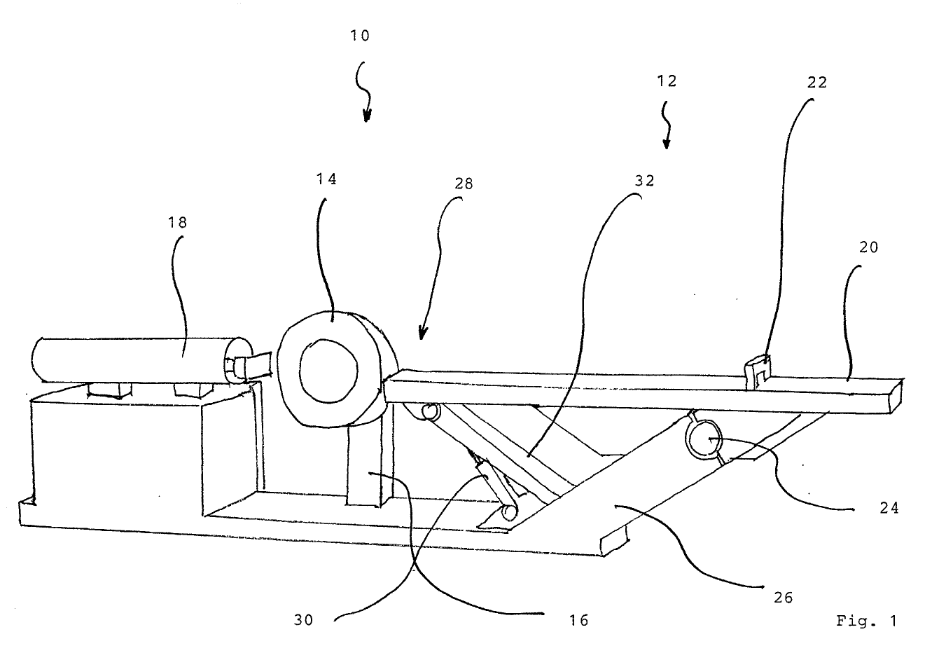

The tire building machine illustrated in FIG. 1 includes a tread strip feed device 12 via which a tread strip (not illustrated) is fed to a buffed carcass 14. The carcass 14 is rotatably mounted on a carcass mounting support 16. The carcass has been prepared with a binding rubber layer or coating built thereonto via a binding rubber layer extruder 18 in accordance with the CTC (Cushion-To-Casing) technology.

The tread strip feed device 12 includes a path support assembly 20 supported on a guide rail (not illustrated). The path support assembly 20 is displaceable relatively toward and away from the carcass 14 and includes, on its upper surface, rollers (not illustrated) configured in a conventional manner along which the tread strip can move in a friction-free manner. Additionally, the path support assembly 20 includes a cutting device 22 which is schematically shown in FIG. 1 and which is operable to cut the tread strip to the desired length.

The path support assembly 20 is, together with its guide rail, mounted in a manner for swing movement. In this connection, a linkage 24 is provided which makes possible a swing movement of the path support assembly 20 relative to a frame 26 of the tire building machine 10. During the swing movement of the path support assembly 20, an end 28 thereof, which is disposed adjacent the carcass 14, is raised. In this connection, a working cylinder 30, which acts upon a support leg 32, serves as a portion of the guide rail.

Additionally, the path support assembly 20 includes a horizontal drive assembly (not shown) via which the path support assembly is displaceable in a substantially horizontal manner relative to the support leg 32 and also relative to the linkage 24. In this manner, the swing position as well as the horizontal position of the path support assembly 20 can be adjusted as desired.

In the operational position shown in FIG. 1, the path support assembly 20 is in the preparation position. In this position, the tread strip can be prepared in a manner, for example, in which the cutting device 22 cuts the tread strip to the desired length.

Once the preparation has been concluded, the path support assembly 20 can be adjustably moved into a feed position. In this connection, the horizontal drive assembly is operated to initially move the end 28 toward the carcass 14. A sensor is mounted on the end 28 which senses the approach of the carcass surface. In view of the fact that the carcass support in the operational position shown in FIG. 1 is not horizontally displaceable, the value of the carcass diameter can be derived from the sensing of the carcass by the sensor. The path support assembly 20 is then raised by the working cylinder 30 and brought into the feed position. In this connection, both the pivoting of the path support assembly via the linkage 24 as well as the horizontal movement of the path support assembly is effected as a function of the carcass diameter so that precisely that desired feed position is achieved in which the tread strip extends tangentially to the carcass surface.

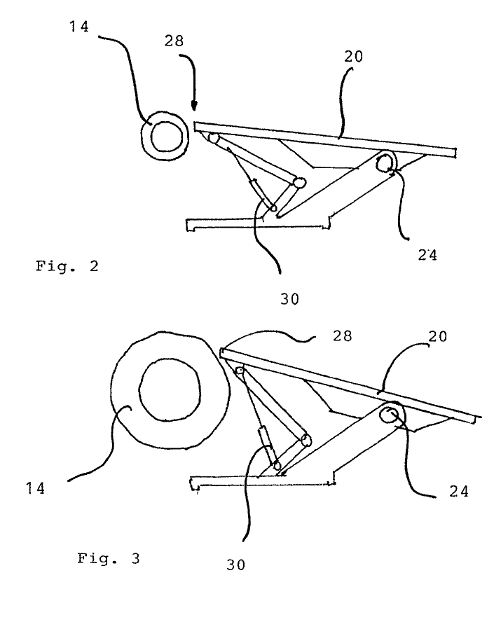

Corresponding feed positions can be seen in FIGS. 2 and 3, whereby FIG. 2 shows a carcass with a small diameter and FIG. 3 shows a carcass with a large diameter.

The specification incorporates by reference the disclosure of German priority document 101 04 774.6 of Feb. 2, 2001.

The present invention is, of course, in no way restricted to the specific disclosure of the specification and drawings, but also encompasses any modifications within the scope of the appended claims.

What is claimed is:

1. A tire building machine, comprising:
a carcass support on which a carcass is rotatably mounted; and
a tread strip feed device via which a tread strip is fed onto the carcass, the tread strip feed device including a linear path support assembly on which a tread strip can be supported in a substantially linear disposition, the path support assembly extending from an end of the tread strip feed device at which a cutting device may perform a cutting operation to another end more closely adjacent the carcass, the tread strip feed device being raisable to a feed position at which the tread strip extends tangentially relative to the carcass for feeding the tread strip thereonto in a tire building process.

2. A tire building machine according to claim 1, and further comprising a linkage disposed under the path support assembly of the tread strip feed device and, in particular, in a region underneath the cutting device, the linkage being operable to effect a swing movement of the tread strip feed device.

3. A tire building machine according to claim 1, wherein the path support assembly is mounted for swing movement and is moveable toward and away from the carcass.

4. A tire building machine according to claim 1, and further comprising a sensor mounted on the end of the path support assembly disposed more closely adjacent the carcass, the sensor being operable to sense an approach of the path support assembly and the carcass toward one another.

5. A tire building machine according to claim 1, wherein the path support assembly extends horizontally in a preparation position thereof.

6. A tire building machine according to claim 1, wherein the path support assembly can be displaced to a spacing of at least 20 cm and, preferably, approximately 40 cm, from the carcass.

7. A tire building machine according to claim 1, wherein the path support assembly includes conventional rollers which are arranged in a sufficiently closely adjacent relationship to one another that a tread strip rollingly supported thereon cannot substantially hang into the spaces between adjacent rollers.

8. A tire building machine according to claim 1, wherein the path support assembly is raisable into a feed position by means of a lifting assembly comprising, in particular, a hydraulic working cylinder and, in particular, the parameters of the lifting operation are determined as a function of the carcass diameter sensed by the sensor.
